(19) United States
(12) Patent Application Publication
(10) Pub. No.: US 2009/0112260 A1
(43) Pub. Date: Apr. 30, 2009

(54) Multipurpose rings

(76) Inventors: George Renko, Des Moines, IA (US); Tatiana Renko, Des Moines, IA (US)

Correspondence Address: Cislo & Thomas LLP, 1333 2nd Street, Suite #500, Santa Monica, CA, 90401-4110, US

(21) Appl. No.: 12/286,664

(22) Filed: Oct. 1, 2008

Related U.S. Application Data
(60) Provisional application No. 61/000,478, filed on Oct. 26, 2007.

(51) Int. Cl. A61J 17/02; A61J 17/00

(52) U.S. Cl. 606/235

(57) ABSTRACT

A multipurpose ring structure comprising a plurality of rings connected together and arranged at 120 degree angles to each other. The individual rings may be hollow or solid. In hollow embodiments, the rings may be filled with other substances. The multipurpose ring may be used as a toy, rattle, or teething ring.

### CROSS-REFERENCE TO RELATED APPLICATION

This patent application claims the benefit of U.S. Provisional Patent Application Ser. No. 61/000,478, entitled “Multipurpose Rings,” filed Oct. 26, 2007, which application is incorporated in its entirety here by this reference.

### TECHNICAL FIELD

This invention relates to toys for children and babies.

### BACKGROUND

There is a constant need to mentally stimulate babies with tactile, visual, and auditory stimuli to promote proper intellectual development. In addition, there is a constant need to motivate young children to exercise to promote physical health. Many toys designed to stimulate babies require a multifarious parts and electrical connections that can be costly to manufacture and easily damaged. In addition, after a certain age, babies' toys are no longer appropriate for young children. For example, young children no longer play with rattles or teething rings.

Young children are too frequently caught up watching television or playing video games. Such inactivity creates a habit that can lead to obesity and other health problems. As young children are easily bored, new toys are needed to encourage them to engage in physical activity that is inexpensive and can be played with anywhere.

An ideal toy would be one that can provide mental stimulation for babies and be used later in life as a child's toy.

### SUMMARY OF THE INVENTION

The present invention is directed towards a highly symmetrical, three dimensional multipurpose ringlet comprising six rings connected at approximately 120 degree angles. The rings may be made with a variety of materials depending on the necessary use. The rings may also be a variety of colors and textures.

The multipurpose ringlet may be used by babies to provide tactile, visual and/or auditory stimulation to help improve manual dexterity and arouse other senses. Babies may also use the toy to pacify their needs or discomforts such as the need to suckle or the discomfort from teething.

Another object of the invention is to provide a new toy for young children to engage in physical activity.

### BRIEF DESCRIPTION OF THE DRAWINGS

FIG. 1 is a perspective view of an embodiment of the present invention;

FIG. 2 is a top view of an embodiment of the present invention;

FIG. 3 is a bottom view of an embodiment of the present invention;

FIG. 4 is a perspective view of another embodiment of the present invention;

FIG. 5 is a top view of an embodiment of the present invention;

FIG. 6 is a cross-section of a top view of an embodiment of the present invention;

FIG. 7 is a cross-section of a top view of an embodiment of the present invention.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

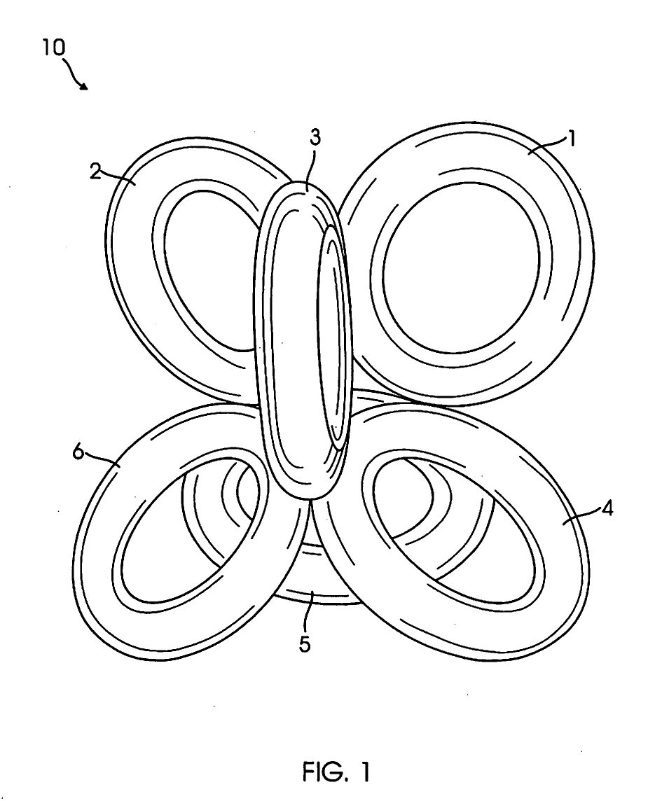

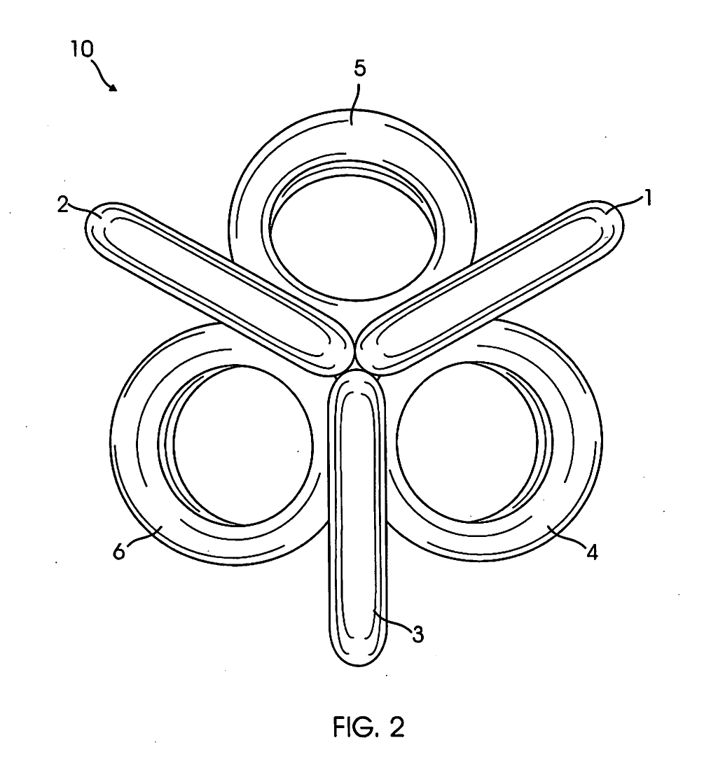

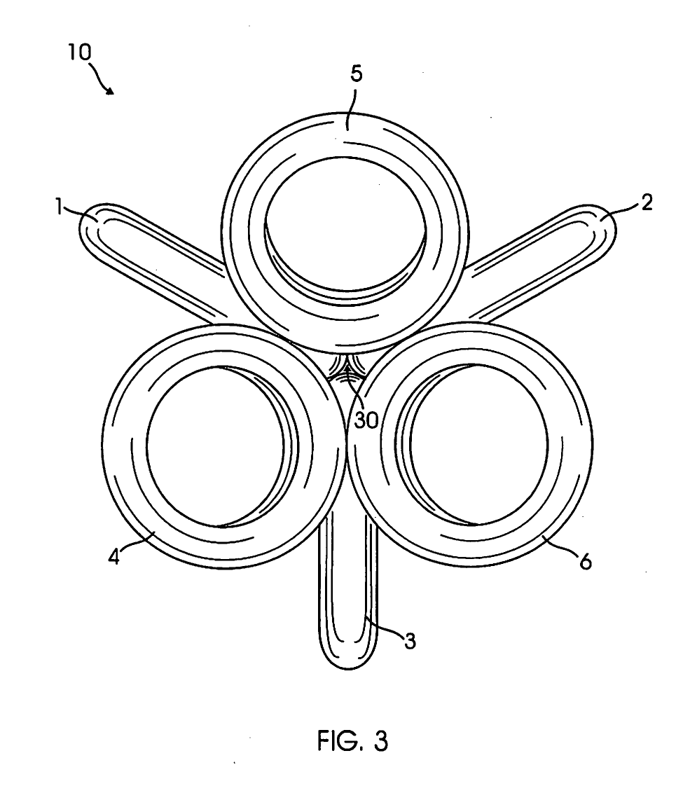

As shown in FIGS. 1-3, the multipurpose ring structure comprises a plurality of rings 1-6 or torus-like objects arranged in a predetermined orientation relative to each other. In certain embodiments, disks may be used. In some embodiments, the multipurpose ring comprises six rings 1-6 with each ring 1-6 adjacent to four other rings. For example, as shown in FIGS. 1-3, a first ring 1 is adjacent and connected to a second 2, third 3, fourth 4, and fifth 5 ring each at approximately a 120 degree angle. The first ring 1 and a sixth ring 6 are non-adjacent and positioned at opposite sides and may be oriented perpendicular to each other. In other words, non-adjacent ring pairs may be perpendicular relative to each other. A single ring may be in contact with four other rings at any given time. Each ring may be a part of a non-adjacent ring pair. Thus, with reference to the figures, the second and fourth rings 2, 4 also make up non-adjacent ring pairs. In addition, the third and fifth rings 3, 5 make up non-adjacent ring pairs. Thus, in the preferred embodiment, three non-adjacent ring pairs are formed, wherein for each ring pair the two rings making up the non-adjacent ring pairs are perpendicular to each other.

In certain embodiments, each ring 1-6 is identical in shape, size, and dimension as the other rings. Using identical rings arranged at 120 degree angles relative to each other creates a generally pyramidal shaped cavity or structure at the center 30 of the multipurpose ring 10 with the contact points making up the vertices of the pyramid. In other embodiments, each ring 1-6 may be different from the other. For example, at least one ring may be a different color, have a different texture, or be a different size or dimension.

The rings 1-6 may be made out of any rigid material such as hard rubber, hard plastic, wood, or metal, and the like depending on the intended use, thereby creating a rigid structure. In another embodiment, the rings 1-6 may be made out of pliable or elastic material, such as elastic rubber or plastic.

The plurality of rings 1-6 may be attached, connected, or joined to each other in many different ways. For example, each ring 1-6 may be manufactured separately then attached by welding, gluing, stitching, clamping, tying, strapping, hook-and-loop fasteners, and the like. The rings 1-6 may also be permanently attached or removably attached. In other words, each ring 1-6 may be detachable from the multipurpose ring 10. For example, each ring 1-6 may comprise a removable fastener, such as the hook-and-loop fastener. Alternatively, the rings 1-6 may have physical protrusions and receivers to allow the rings to directly interconnect with each other. In addition, the rings may be flexibly attached or rigidly attached.

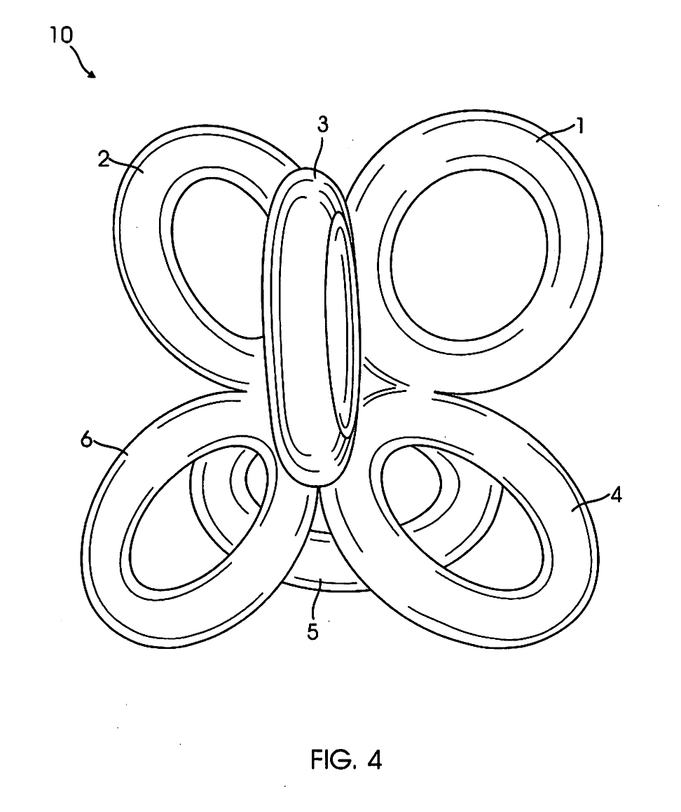

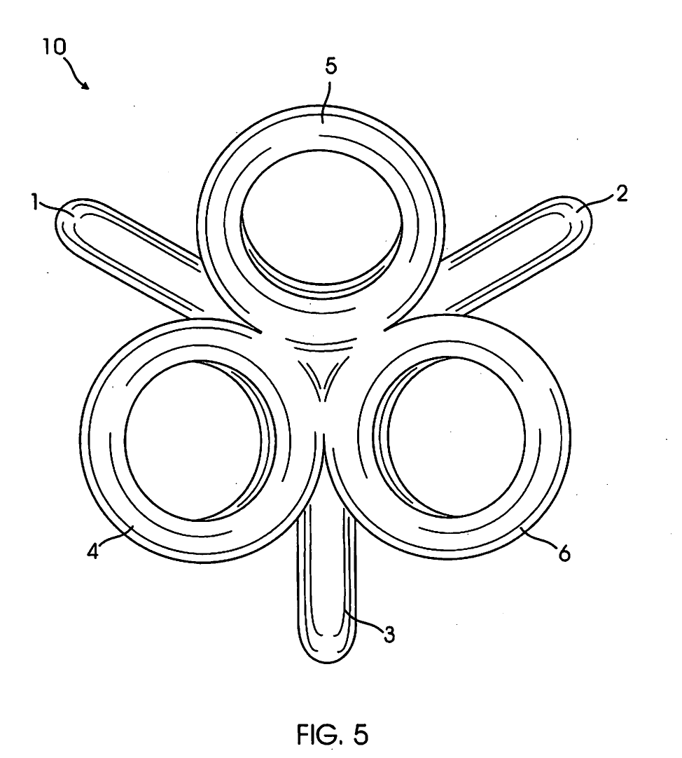

In some embodiments, as shown in FIGS. 4 and 5, the rings 1-6 may be constructed as one integral, unitary piece.

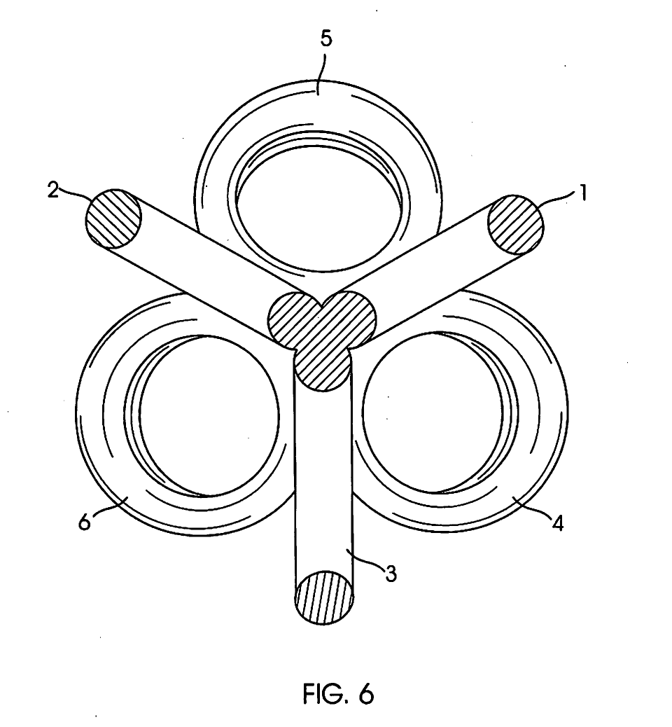

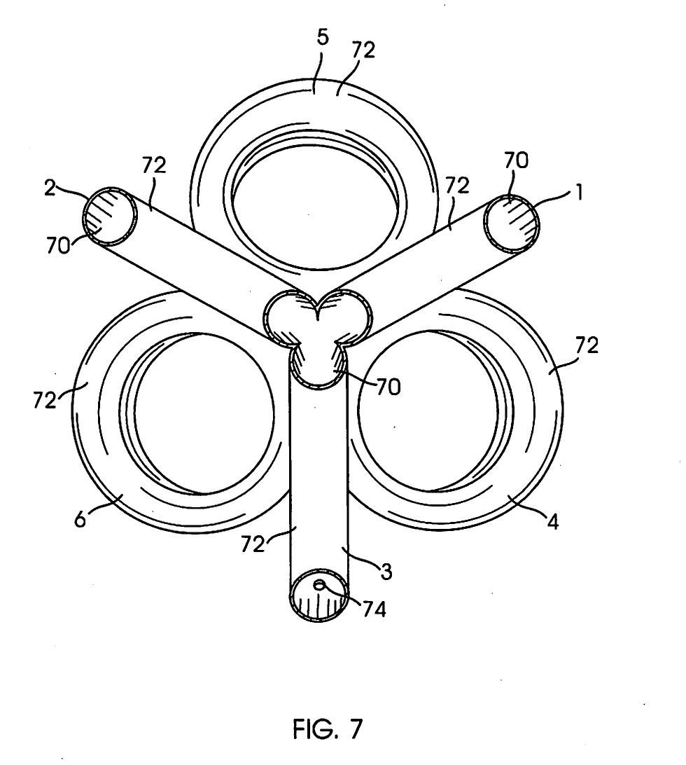

In some embodiments, as shown in FIG. 7, at least one of the rings 1-6 may be hollow or tubular, and therefore comprise an inner surface 70 and an outer surface 72. In other embodiments, at least one of the rings 1-6 may be solid throughout as shown in FIG. 6. In the hollow embodiments, the rings 1-6 may be filled with a variety of substances and materials such as a gas, a fluid, a solid, a semi-solid material, or any other material that can fill a hollow tube. For example, the rings 1-6 may be filled with air, water, oil, sand, pebbles, gel, or any combination thereof. These substances may be of a variety of different colors. Each ring may have the same substance or a different substance. In some embodiments with different substances, the inner surface 72 of each ring should be separate or discontinuous from the other to avoid mixing of different substances. The fillable embodiments provide the additional visual and/or audio stimulation for the user. The rings 1-6 may be partially filled or completely filled.

In hollow embodiments, at least one of the rings 1-6 may further comprise a sealable orifice 74. The orifice 74 may be a simple opening with a cap or lid. The cap or lid may create an airtight or watertight seal to prevent any substance from leaking out when the rings are filled. Alternatively, the orifice 74 may be an airtight rubber orifice as used in inflatable balls. Thus, filling material may be poured into the rings 1-6 or injected into the rings 1-6 and sealed closed.

In the hollow embodiments, each ring 1-6 may be interconnected with each other providing continuity or contiguity between the inner surfaces 70 of each ring 1-6. Thus, in embodiments where filling is desired, the entire multipurpose ring 10 may be filled through one ring. Alternatively, each ring 1-6 may be sealed off from the other so that no inner continuity exists among the rings. Alternatively, certain rings may have inner continuity with some rings while being separate from other rings.

The rings 1-6 may be transparent, translucent, or opaque. Thus, in hollow embodiments, the inner contents of the rings 1-6 may be seen, thereby, providing additional stimuli.

In some embodiments, the rings have smooth exterior surfaces making the multipurpose ring 10 pleasing to touch. In other embodiments, the rings 1-6 may be ergonomically designed with a series of concavities or dips that can serve as grips. In other embodiments, the rings 1-6 may have bumps or protrusions. In other embodiments, the rings may have dimples.

The multipurpose ring 10 may be used in recreation as a toy or a sporting good. The unique configuration makes it challenging to play catch with. As a user throws the multipurpose ring, the multipurpose ring may spin in a variety of directions and with at various speeds. The multipurpose ring 10 is most easily caught when the user can fully grasp one of the rings. Due to the unique orientation of the rings, this is a possible but a difficult task. A variety of games of catch can be created by assigning different points for catching the multipurpose ring 10 by a ring 1-6 of a specific color, texture or size.

In other embodiments, the multipurpose ring may be used by babies, for example, as an improved mentally stimulating, teething ring, rattle, or the like. Unlike simple teething rings, the convoluted appearance may be aesthetically pleasing and stimulating to a baby. In addition, due to the multiple rings 1-6, the baby can choose from a number of different grasping positions while providing a convenient biting surface. In some embodiments, additional stimuli may be provided by providing rings of different colors and textures.

The foregoing description of the preferred embodiment of the invention has been presented for the purposes of illustration and description. It is not intended to be exhaustive or to limit the invention to the precise form disclosed. Many modifications and variations are possible in light of the above teaching.

What is claimed is:

1. A multipurpose ring, comprising: a plurality of rings, each ring forms a connection with at least two other rings at approximately 120 degree angles, wherein each of three pairs of rings forms a non-adjacent ring pair, wherein for each non-adjacent ring pair, the two rings of the non-adjacent ring pair are perpendicular to each other.

2. The multipurpose ring of claim 1, wherein the plurality of rings are integrally formed.

3. The multipurpose ring of claim 1, wherein at least one ring is hollow.

4. The multipurpose ring of claim 3, wherein each ring is hollow and each ring comprises an inner surface and an outer surface wherein, the inner surface of each ring is contiguous with the inner surface of at least one other ring.

5. The multipurpose ring of claim 3, wherein the at least one ring is filled with a substance selected from the group consisting of a gas, a fluid, a solid, and a semi-solid.

6. The multipurpose ring of claim 5, further comprising a sealable orifice on the at least one ring for filling the at least one ring with the substance.

7. The multipurpose ring of claim 1, wherein the connection is a detachable connection.

8. A multipurpose ring, comprising: six rings, each ring is connected to four other rings at approximately 120 degree angles, wherein each of three pairs of rings form a non-adjacent ring pair, wherein for each non-adjacent ring pair, the two rings of the non-adjacent ring pair are perpendicular to each other, wherein a center of the multipurpose ring forms a generally pyramidal shape.

9. The multipurpose ring of claim 8, wherein the plurality of rings are permanently attached.

10. The multipurpose ring of claim 9, wherein the plurality of rings are integrally formed at the center.

11. The multipurpose ring of claim 10, wherein each ring is hollow and comprises an inner surface and an outer surface.

12. The multipurpose ring of claim 11, wherein the inner surface of each ring is contiguous with the inner surface of another ring.

13. The multipurpose ring of claim 12, wherein each ring is fillable with a substance selected from the group consisting of a gas, a fluid, a solid, and a semi-solid.

14. The multipurpose ring of claim 13, further comprising at least one sealable orifice.

15. A multipurpose ring, comprising: six rings, each ring detachably connected to four other rings at approximately 120 degree angles, wherein each of three pairs of rings form a non-adjacent ring pair, wherein for each ring pair, two rings comprising the non-adjacent ring pair are perpendicular to each other, wherein a center of the multipurpose ring forms a generally pyramidal shape.

16. The multipurpose ring of claim 15, wherein at least one ring is hollow and comprises an inner surface and an outer surface.

17. The multipurpose ring of claim 16, wherein the inner surface of the at least one ring is contiguous with an inner surface of another hollow ring.

18. The multipurpose ring of claim 16, wherein the at least one hollow ring is fillable with a substance selected from the group consisting of a gas, a fluid, a solid, and a semi-solid.

19. The multipurpose ring of claim 18, further comprising at least one sealable orifice.
